(19) United States
(12) Patent Application Publication
(10) Pub. No.: US 2021/0064656 A1
(43) Pub. Date: Mar. 4, 2021

(54) Tree Ring Map for Data Visualization.

(71) Applicant: Annie W. Shum, Hopkinton, MA (US)

(72) Inventor: Annie W. Shum, Hopkinton, MA (US)

(21) Appl. No.: 16/501,133

(22) Filed: Sep. 3, 2019

(51) Int. Cl. G06F 16/904; G06F 16/901; G06F 3/0484

(52) U.S. Cl. CPC G06F 16/904; G06F 3/04842; G06F 16/9027

(57) ABSTRACT

Tree Ring Map for Data Visualization is disclosed. Tree ring map, with the circular shape rings have the nature of non-uniform space allocation for data points with rings that has larger radiuses having more space allocated to present data with more details. The data points presented can be sized and colored, in addition to being placed on the map, based on the information they carry.

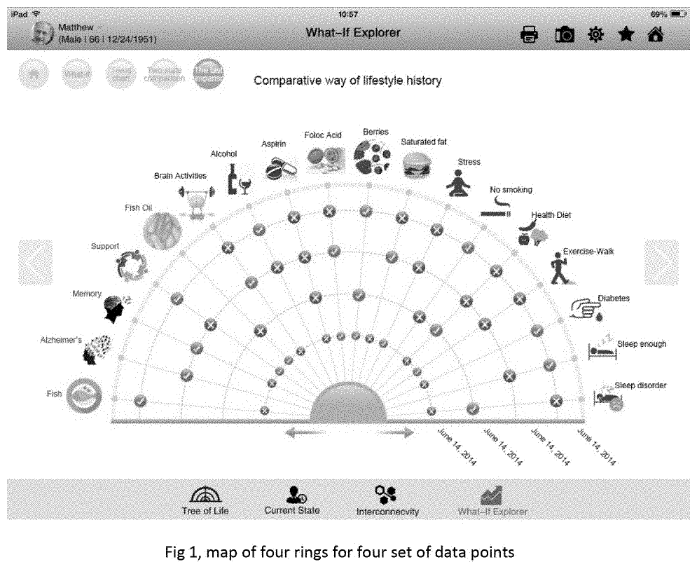

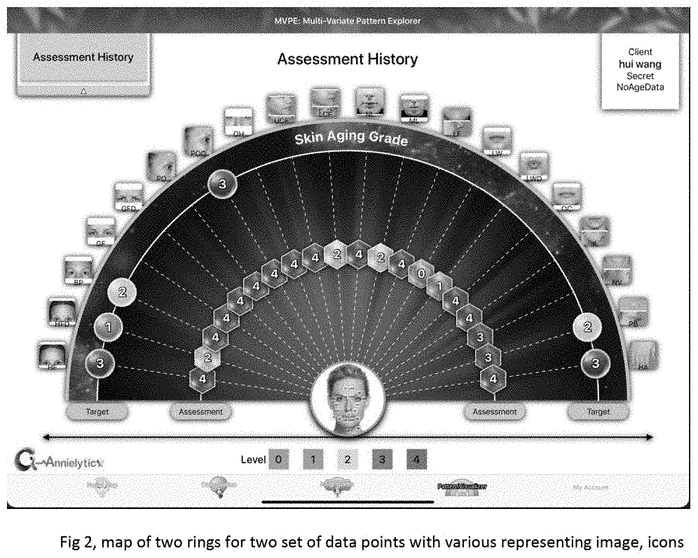

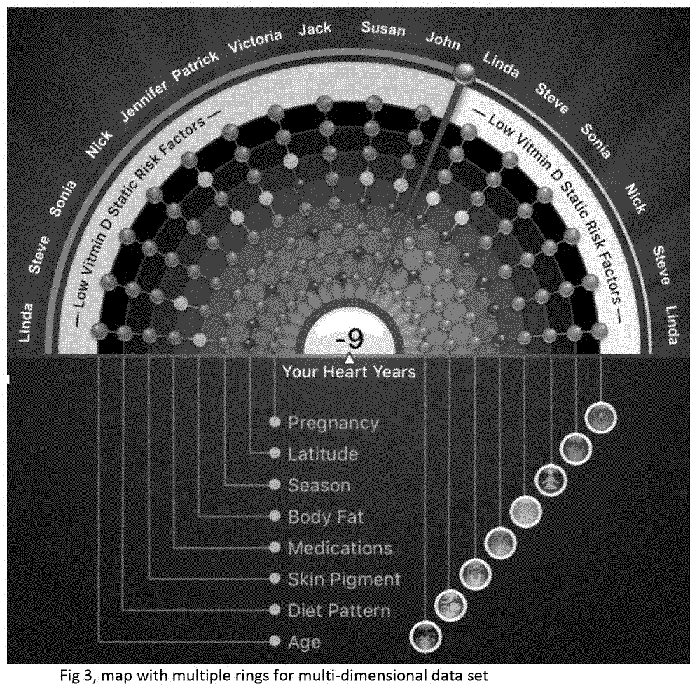

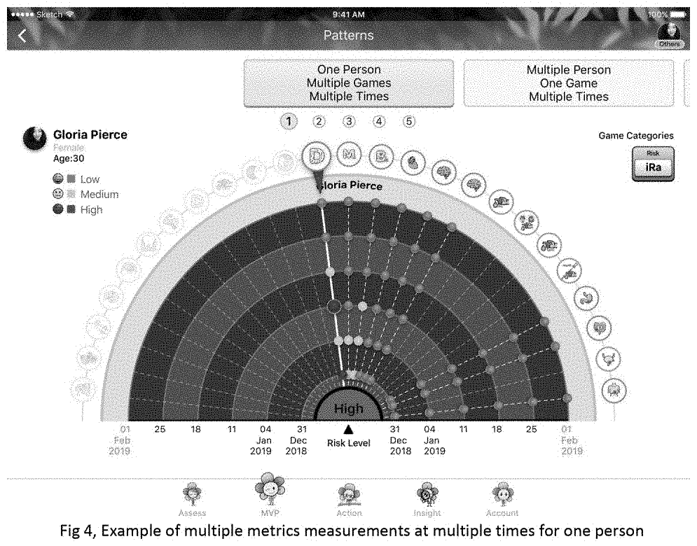

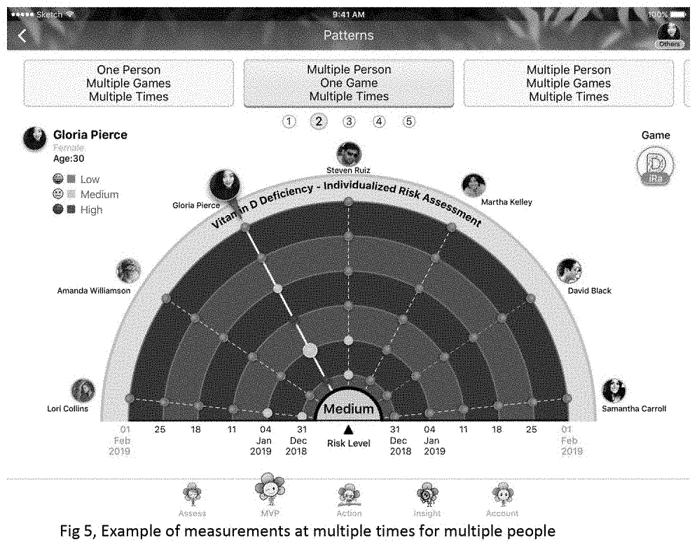

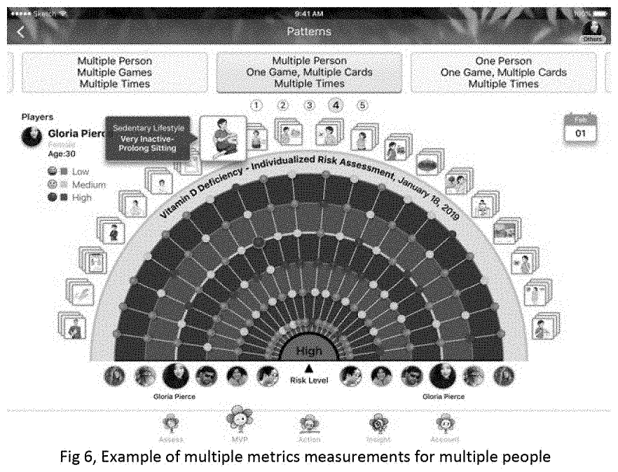

### BACKGROUND OF THE INVENTION

Problem Solved: Data visualization is graphical representation of information and data. It is often done by using visual elements like charts, graphs, timelines, and maps. Often times, visualization of complex data sets cannot effectively attract attentions of targeted users, help targeted users to see or understand the mechanism or patterns in knowledge or information discovery.

The ring is also used as a sorting order representing the importance, weight or priority of data points. Each ring then has a specific attribute set for presenting the data set with various sizes, shapes, colors, patterns or images for presenting data points on the ring. In general, the circular shape rings have the nature of non-uniform space allocation for data points with rings that has larger radiuses having more space allocated to present data with more details.

Tree ring map, with the circular shape rings have the nature of non-uniform space allocation for data points with rings that has larger radiuses having more space allocated to present data with more details. The data points presented can be sized and colored, in addition to being placed on the map, based on the information they carry.

### DETAILED DESCRIPTION OF THE INVENTION

As stated above, Data visualization is graphical representation of information and data. It is often done by using visual elements like charts, graphs, timelines, and maps. Often times, visualization of complex data sets cannot effectively attract attentions of targeted users, help targeted users to see or understand the mechanism or patterns in knowledge or information discovery. The invention claimed here solves this problem.

The present invention is intended for data visualization, user-driven data pattern discovery, visualizing and understanding pattern or correlations exist in large amounts or multi-dimensional data sets. It is a method of placing data points onto allocated graphical visual interfaces for the purpose of presenting visual format or interpretation of presented data sets. The placement of data points on these ring-like curves are dynamically decided based on predefined thresholds, discovered patterns, correlation, clustering or assessment weights among data sets, etc.

The claimed invention differs from what currently exists. The present invention produces a visual graphical presentation of a given data set in the form of circular shape like tree rings. The data placement algorithm is designed to place data points onto the curved rings in an optimal way such that the presentation is visually pleasant to an average user, bring familiarity to tree rings also with the use of various matching colors, patterns, shapes or sizes of a single data point presentation. The ring is also used as a sorting order representing the importance, weight or priority of data points. Each ring then has a specific attribute set for presenting the data set with various sizes, shapes, colors, patterns or images for presenting data points on the ring.

This invention is an improvement on what currently exists. The present invention produces a visual graphical presentation of a given data set in the form of circular shape like tree rings. The data placement algorithm is designed to place data points onto the curved rings in an optimal way such that the presentation is visually pleasant to an average user, bring familiarity to tree rings also with the use of various matching colors, patterns, shapes or sizes of a single data point presentation. The ring is also used as a sorting order representing the importance, weight or priority of data points. Each ring then has a specific attribute set for presenting the data set with various sizes, shapes, colors, patterns or images for presenting data points on the ring.

Usually, large, complex data sets require multiple graphical instruments (charts, lines, and etc.) to be visualized. The existing visualization tools are limited in conveying dense information in a single visualization form.

Tree ring map, with the circular shape rings have the nature of non-uniform space allocation for data points with rings that has larger radiuses having more space allocated to present data with more details. The data points presented can be sized and colored in addition to being placed on the map, based on the information they carry.

### The Version of The Invention Discussed Here Includes:

1. The tree ring map is formed by series of circular rings around center with multiple lines drawn from center position to the outer most ring, across all circular rings. There are groups of rings and groups of lines “cutting” through the rings on the tree ring map. The intersection points between rings and lines are the locations of the data points presented (with text, image, hyperlinks to external source of text, and etc.).
2. The angle position of for each metric is calculated by one of following algorithms: evenly distributed over the allocated angular range, weighted angular distribution by the measurement values, or predefined weights reflecting priorities, severities, relevance or urgency, etc.
3. The ring position is defined by the radius from center position and calculated via one of following algorithms: evenly distributed over a given size of the tree ring map, weighted distance distribution over an allocated distance range by measurement values, predefined weights reflecting priorities, severities, relevance or urgency, etc.
4. The size of each data point visualization on the tree ring map is decided by one of following algorithms: uniform size, weighted size by measurement values, predefined weights reflecting priorities, severities, relevance or urgency, etc.
5. The color of visual presentation of each data point on the tree ring map is decided by one of following color mapping algorithms: use the same color, map to the gradient color table by measurement values, predefined weights reflecting priorities, severities, relevance or urgency, etc.
6. The line width of each ring is calculated via one of following algorithm: uniform size, size proportional to the measurement values, predefined weights reflecting priorities, severities, relevance or urgency, etc.
7. The color of ring is decided by one of following algorithms: same color, mapped to the gradient color table by measurement values, predefined weights reflecting priorities, seventies, relevance or urgency, etc.
8. The width of each straight line is calculated via one of following algorithm: uniform size, size proportional to the measurement values, predefined weights reflecting priorities, severities, relevance or urgency etc.
9. The color of line is decided by one of following algorithms: same color, mapped to gradient color table by measurement values, predefined weights reflecting priorities, severities, relevance or urgency etc.
10. The total ring length (or each space between two adjacent data points on the ring) is larger for rings that have larger radius distance so more details can be presented for the data points. The selection of tree ring for placing the data set can be decided by one of the following factors: importance of data points, priority of data points, and order of data points being collected or any data sorting mechanism.
11. The sorting order of data point placement positions over the rings or lines can be also calculated by correlation, similarities or clustering discovered among data points.

### Relationship Between The Components:

Multiple sets of the above described data placement over “tree ring map” are created reflecting the different aspects or attributes of series data sets such as priorities, correlation, connectivity's, similarities or clustering, etc. The order of series of tree ring maps can be arranged based on the pre-built data exploring “navigation path” that would best describe the nature or underlining mechanism to assist data understanding or discovery. There can be many sets of data exploring “navigation path” built with embedded software implementation of predefined algorithm to dynamically decide the next tree ring map for presentation depends on user's current interactions with tree ring map. The dynamic data exploring “navigation path” aims to let the user drive the process of understanding and discovery the underlining mechanism.

### How The Invention Works:

The present invention comprises a novel data point's presentation over non-uniformed circular shape rings and lines sharing the center point. The data placement positions and sizes are computed based>s on various algorithms that weights the priorities, time of measurements, correlations among data points of similarities or clustering among data points. Multiple “tree ring map” data presentation can be built with embedded running algorithm software to enable static or dynamic data exploring path (or data tree ring map presentation orders) so the following form or shape of data presentation depends on user interaction with current data presentation. Easy understanding, further exploring or discovery of underling mechanisms or relationships among data can be achieved. What is claimed are:
1. Non-uniform data point placement method over half, partial or full circular like rings sharing the same center with straight lines originated from the center.
2. The shape of rings sharing the same center can be of other types of shapes such as the ellipse.
3. The non-uniform nature of described method allows the type of presentation that needs to allocate different graphical layout spaces space for data sets with different attribute values.

### How To Make The Invention:

One would use computer graphics software to read data sets and draw the tree ring map with data points on the map.

### Elements Necessary:

1) Computer graphic software supporting a computer language and compiler
2) Computer hardware supporting visualization display

### Optional:

1) Computer operating systems with advanced graphical capabilities (such as MacOS or iOS, which is better than Windows or Linux)
   How To Use The invention:
1) Write software (on computer hardware, with a language and compiler for computer graphics) to read in data
2) Have the software draw the tree ring map
3) Display the data points on tree ring map

1. A computer-implemented method for providing an interactive data visualization user interface for a data set, wherein the method comprises:
generating a first visual map using the data set by:
(i) selecting, from a set of attributes of the data set, a set of vector attributes;
(ii) deriving a set of point values from the data set; and
(iii) distributing a set of graphical value representations of the set of point values along a set of physical vectors, wherein the set of physical vectors represent values of the set of vector attributes;
receiving a selection of at least one selected attribute value via one of: (i) a graphical representation from the set of graphical value representations; and (ii) a vector in the set of physical vectors;
slicing the at least one selected attribute value from the data set to form a second layer data set; and
repeating the generating step to generate a second visual map using the second layer data set.
